(19) United States
(12) Patent Application Publication
(10) Pub. No.: US 2022/0207631 A1
(43) Pub. Date: Jun. 30, 2022

(54) SYSTEMS AND METHODS FOR AGENT ANALYTICS

(71) Applicant: AgentStory, Inc., Miami, FL (US)

(72) Inventors: Gilad N. Weic, Fort Lauderdale, FL (US); Ronen Cohen, Gesher Haziv (IL); Jonathan J. Cardella, Boise, ID (US)

(21) Appl. No.: 17/646,470

(22) Filed: Dec. 29, 2021

Related U.S. Application Data
(60) Provisional application No. 63/132,775, filed on Dec. 31, 2020.

(51) Int. Cl. G06Q 50/16; G06F 16/29

(52) U.S. Cl. CPC G06Q 50/16; G06F 16/29

(57) ABSTRACT

Systems and methods for performing agent analytics are disclosed herein. In some embodiments, an agent analytics system receives, from a user device, an identification of a location of interest; receives listings data for an agent from one or more agent databases; selects listings of the listings data for the agent that are within a geography level corresponding to the location of interest and that are of one of one or more listing types; generates, based on the selected listings, polygon data for a polygon (e.g., corresponding to a map) representing an activity area of the agent for the one or more listing types; and sends the first polygon data to the user device. In some embodiments, the agent analytics system receives an identification of the agent from the user device (e.g., instead of a location of interest), and then proceeds to accordingly generate polygon data to send to the user device.

### CROSS-REFERENCE TO RELATED APPLICATIONS

The present application claims the benefit of priority under 35 U.S.C. Section 119(e) of U.S. Provisional Patent Application No. 63/132,775, entitled SYSTEMS AND METHODS FOR REAL ESTATE AGENT ANALYTICS, filed Dec. 31, 2020, which is hereby incorporated herein by reference in its entirety.

### BACKGROUND

Real property owners (sometimes referred to herein as “owner(s)” or “seller(s)”) wishing to sell their real property (sometimes referred to herein as “property”) or real property buyers (sometimes referred to herein as “buyer(s)”) wishing to buy real property often employ real estate agents (sometimes referred to herein as “agent(s)”) to facilitate these transactions. The agent may handle one or more various aspects of the sales or purchasing process, including, for example, market research, price setting, marketing, scheduling showings of the property, and/or negotiation of terms. Accordingly, the selection of a proficient real estate agent who is likely to achieve a successful outcome can be of great economic importance to one or both the owner and/or the buyer. Further, since the geographical area in which a piece of real property is found and the property itself are both inherently unique in many ways, it is often desirable to employ an agent who is familiar with the area and has a good track record of successful outcomes when buying or selling similar properties in the area. However, current systems and methods for use by an owner and/or a buyer to evaluate an agent's experience and performance with respect to a specific property, or within a specific geographic area, are lacking.

### BRIEF SUMMARY

The present disclosure provides embodiments of computer-implemented systems and methods for analyzing and displaying performance metrics of agents (and/or entities related thereto), which may enable recommending agents for a given listing (or transaction) involving a property.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagram of a system for performing agent analytics with a detailed view of an agent analytics system, in accordance with an embodiment of the disclosure.

FIG. 2 illustrates an example of a resulting polygon of a polygon drawing process, according to one or more embodiments herein.

FIG. 3 illustrates the presentation of data on a user device of a backend user, according to one or more embodiments herein.

FIG. 4 illustrates the presentation of data on a user device of a frontend user, according to one or more embodiments herein.

FIG. 5 illustrates the presentation of data on a user device of a frontend user, according to one or more embodiments herein.

FIG. 6 illustrates a presentation of data on a user device of a frontend user, according to an embodiment.

FIG. 7 illustrates a method for performing real estate agent analytics, according to one or more embodiments herein.

FIG. 8 illustrates a method of an agent analytics system, according to an embodiment.

FIG. 9 illustrates a method of an agent analytics system, according to an embodiment.

### DETAILED DESCRIPTION

Systems and methods are disclosed herein that relate to analyzing performance metrics and/or experience related to aspects of buying or selling a property, in order to provide recommended employment of an agent (or entity related to that agent, such as an agent team) for a particular listing or transaction. Further, the disclosed systems and methods describe the display of such information in a useful way to a user of such systems using these methods.

Agent analytics may include the presentation of information about an agent, the evaluation of performance indicators of an agent, the selection of an agent, making predictions regarding the performance of an agent, analyzing historical data pertaining to the agent, etc., as will be described herein. Generally, the property will be real property (e.g., as involved in a real estate transaction), and yet the technology described herein can pertain to other forms of property, such as automobiles, boats, businesses, intangible property (e.g., intellectual property, mineral rights, water rights, easements, licenses), etc.

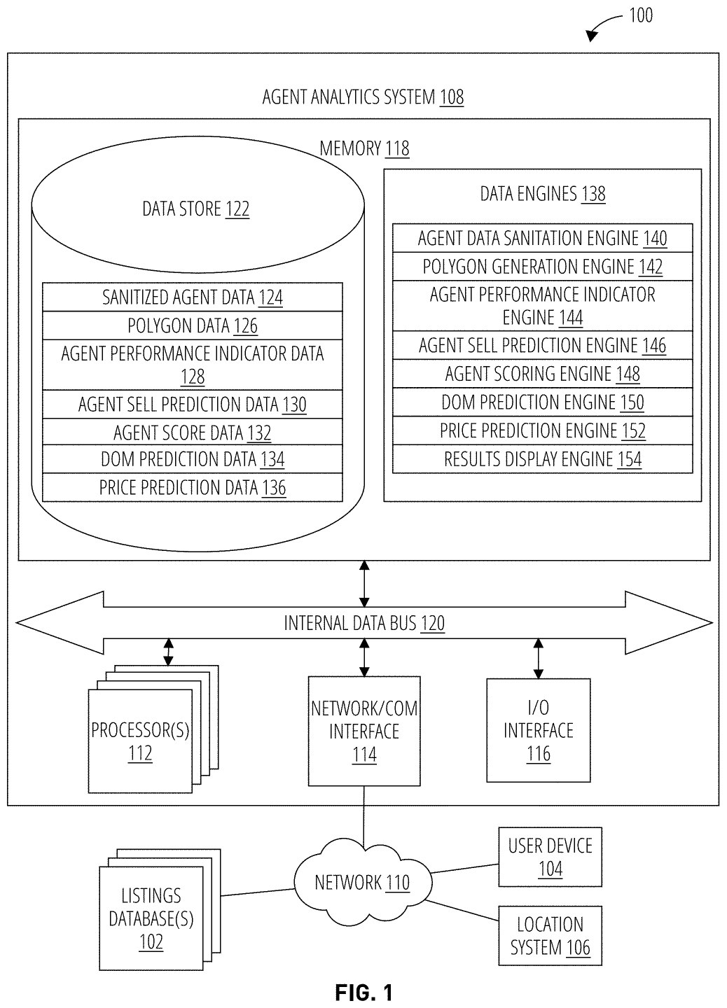

FIG. 1 illustrates a system 100 for performing agent analytics with a detailed view of an agent analytics system 108, in accordance with an embodiment of the disclosure. The system 100 includes the agent analytics system 108, one or more listings database(s) 102, a user device 104, and a location system 106, each of which is communicatively connected via a network 110.

The one or more listings database(s) 102 may include listings data about various agents and their related listings, and past transactions, in an unanalyzed form. Examples of this listings data include, for example, the agent for a listing, the location (e.g., address, GPS coordinates) of the property that is the subject of the listing, the sale price of said property, the number of days on market of said property, whether the property sold or not, and details or characteristics about the property such as the size of the lot, the square footage of the building, and the allotment of rooms, among other options. This listings data may be sent via the network 110 to the agent analytics system 108. The agent analytics system 108 may then sanitize and/or otherwise process this listings data, using one or more data engines 138, in the manner that will be described in further detail below. It is further contemplated that the agent analytics system 108 could pull specific listings data from the listings database(s) 102 that are at or within a geographical area related to the processes to be described herein, such that not all listings that exist are necessarily pulled for the agent from the listings database(s) 102. The one or more listings database(s) 102 may be operated by the users and/or operators of the agent analytics system 108, or in some cases may instead be operated by other parties.

The user device 104 may be used to send operational commands to and/or receive data from the agent analytics system 108 via the network 110, in the manner that will be further described below.

The location system 106 may be a system that can take as input over the network 110 a property's physical address and determine the set of GPS coordinates for the provided address. An indication of a match or non-match may be sent by the location system 106 to another entity of the system 100 over the network 110. The location system 106 may also be capable of receiving a property's physical address and determining and/or returning the matching set of GPS coordinates.

Turning now to the agent analytics system 108 more specifically: the agent analytics system 108 includes a memory 118, one or more processor(s) 112, a network/COM interface 114, and an I/O interface 116, each of which may be communicatively connected via an internal data bus 120.

The processor(s) 112 of the agent analytics system 108 may be used to drive the functions of the agent analytics system 108 (e.g., by operating the functions of one or more of the data engines 138, as will be described below).

The network/COM interface 114 of the agent analytics system 108 may be connected to the network 110 and may act as a reception and/or distribution device for computer-readable instructions. This connection may facilitate the transfer of information (e.g., computer-readable instructions, data, etc.) from the agent analytics system 108 to and from the listings database(s) 102 and to and from the user device 104. The network 110 may be any network connection or device using network communications methods familiar to those with skill in the art.

The I/O interface 116 of the agent analytics system 108 may permit the entry of data into and/or the output of data from the agent analytics system 108. The I/O interface 116 may connect to various physical or virtual peripherals, to accomplish this input and/or output, such as one or more keyboards, one or more mice, one or more monitors, one or more printers, etc.

The memory 118 of the agent analytics system 108 includes a data store 122 and the data engines 138. The data store 122 may include sanitized agent data 124, polygon data 126, agent performance indicator data 128, agent sell prediction data 130, agent score data 132, days on market (DOM) prediction data 134, and price prediction data 136. The data engines 138 may include an agent data sanitation engine 140, a polygon generation engine 142, an agent performance indicator engine 144, an agent sell prediction engine 146, an agent scoring engine 148, a DOM prediction engine 150, a price prediction engine 152, and a results display engine 154. In many instances, the data of the data store 122 may be generated by a related engine of the data engines 138 as such data engines 138 are operated by the processor(s) 112 (as will be described in further detail below).

The sanitized agent data 124 includes listings data imported from one or more listings database(s) 102. The sanitized agent data 124 may be data that has been sanitized by the agent data sanitation engine 140. Because the listings database(s) 102 may hold listings data as diverse types of data across multiple arrangements, content inclusions, and/or data formats, the agent data sanitation engine 140 receives this listings data (via the network 110) and sanitizes it by placing it in a single content arrangement and/or file format and stores such data as the sanitized agent data 124.

The process performed by the agent data sanitation engine 140 may remove portions of the listings data (e.g., individual listing(s)) received from the one or more listings database(s) 102 that is incorrect and/or too incomplete to be usefully included in the sanitized agent data 124, such as listings information where the agent associated with the listing is indeterminable or the geolocation of the property associated with the listing is incorrect. The agent data sanitation engine 140 may further resolve issues where multiple agents or teams of agents are associated with one listing (e.g., these may be credited to the team lead and/or one of the agents). For example, in listings that specify agent co-listing data, this process may, for example, resolve the attribution of the listing to one of the agents, as appropriate. The agent data sanitation engine 140 may also generate reference entities for a listing like agents, zip codes, counties and cities (to the extent that this information is not already present in the listing), perhaps via cross-referencing with one or more other listings or other information found on the one or more listings database(s) 102, the already-stored sanitized agent data 124 and/or an outside system (such as the location system 106). For example, to the extent some location information useful to the agent analytics system 108 is not present in a listing but can be found based on another portion of the data from the listing (e.g., to the extent the zip code, city, GPS coordinates, etc., are derivable from the address of the listing (perhaps through communications with an outside device such as the location system 106 or another outside device)), the agent data sanitation engine 140 may add this information to the listing as part of the sanitation process.

The agent data sanitation engine 140 may also validate the listings data. For example, some of the listings data (e.g., individual listing(s)) received from the one or more listings database(s) 102 may have incorrect location information (e.g., incorrect GPS coordinates). Accordingly, the agent data sanitation engine 140 may communicate with the location system 106 via the network 110 in order to validate the location information for each listing (and, e.g., remove listings with incorrect location information).

Further, the target variable for one or more machine learning predictive processes (described below) may be designated at this stage, based on the analytics or predictions that may be requested.

The process performed by the agent data sanitation engine 140 may also include a form of anonymization, which may remove or modify portions of the listings data that are considered sensitive. For example, an exact sales price may be rounded (e.g., to a nearest representative value) or presented instead as a representative range. As another example, personal information of a buyer and/or seller (such as names, ages, social security numbers, etc.), may be removed. This anonymization may be responsive to requirements (including requirements by third parties) for users and/or operators of the agent analytics system 108 and/or requirements for users and/or operators of the listings database(s) 102.

The process performed by the agent data sanitation engine 140 may also set portions of one or more listings that are incomplete to empty (for example, a listing that only has partially complete agent co-listing data may have all of its agent co-listing data set to empty). This process may also extract and separately record sub-portions of an address (e.g., unit/apartment number) from an address field, as appropriate.

The polygon data 126 includes data defining polygons that represent a visualization of an agent's activity area (e.g., as visualized against a map) as generated by the polygon generation engine 142. The polygon generation engine 142 may use the sanitized agent data 124 to generate these polygons. The polygons generated by the polygon generation engine 142 and stored in the polygon data 126 may be of different types that correspond to listing types (e.g., sold listings, unsold listings, listings where the agent represented a buyer, listings where the agent represented a seller, etc.) used to generate that polygon. In some embodiments, the listing type(s) so used to generate the polygon may be identified by the user via the user device 104 (either directly, or by the user selecting for a corresponding polygon type to those listing types).

A first type of polygon is an Activity Polygon, which visualizes the activity area of an agent (an area based on an agent's sold and unsold listings—i.e., Seller Side Activity). A second type of polygon is a Performance Polygon (an area based on an agent's sold listings—i.e., Seller Side Performance). A third type of polygon is a Buyer's Side Polygon (an area based on an agent's listings for which they were the agent for the purchaser of a property). A fourth type of polygon is an Activity Plus Buyer's Side Polygon (an area based on the combination of the Activity Polygon and the Buyer's Side Polygon that gives a complete visualization of the agent's activity on both the sell side and the buy side). As can be appreciated, other types of polygons (with other types of corresponding listings) are also possible.

For purposes of this disclosure, a “polygon” may also include linestrings (e.g., polygons where the property geo-coordinates in the data set corresponding to the linestring in the polygon data 126 form a line on the map rather than a true polygon) and individual points (e.g., data sets where the property geo-coordinates in the data set corresponding to the individual point in the polygon data 126 form a point on the map, as in the case of multiple apartment buildings and/or units with the same address).

Some embodiments herein contemplate that polygons may be relevantly presented in relation to a particular location of interest provided to the agent analytics system 108 by the user. A location of interest may be, for example, an address, a zip code, a city, a county, etc., that is identified to the agent analytics system 108 by the user via the user device 104.

Embodiments herein may operate according to one or more geography levels. Examples of geography levels include a worldwide geography level, a country geography level, a city geography level, a zip code geography level, a county geography level, a region geography level (e.g., representing a neighborhood or other geographic area), and/or location geography levels involving single points (e.g., an address, a building, etc.), among other possibilities. It is contemplated that in some embodiments, one or more relevant geography level(s) may be provided to the agent analytics system 108 by the user via the user device 104.

In embodiments herein that use locations of interest, a geography level may be understood to correspond to a location of interest when, for example, it is or includes (or includes at least in part) the location of interest. For example, there may be a zip code geography level that includes a location of interest that is an address, a city geography level that includes an address or zip code that is the location of interest, or that is (the same as) a city of interest, etc.

Polygons for the polygon data 126 may be generated by the polygon generation engine 142 based on one or more of these different geography levels (e.g., a city geography level, a zip code geography level, a county geography level, a region geography level (e.g., neighborhood or other geographic area), geography levels involving single points (e.g., an address, a building, etc.), and so on). Such polygons may be for display on (e.g., correspond to) a map that shows the corresponding geography level.

In embodiments where a location of interest is indicated by the user, these polygons may be formed corresponding to the location of interest. For example, listings selected for use in generating polygons may be selected based on their proximity to a specific property or other location of interest (e.g., a city, a zip code, etc.) for which the user of the agent analytics system 108 wants to perform an analysis as indicated by the user using the user device 104. This selection may correspond to one or more of the geography levels described above. For example, it may be determined to use listings within a zip code geography level of the location of interest (and/or perhaps the surrounding zip codes) to draw a polygon for an agent. In another example, it may be determined to use listings within a single point granularity (e.g., a single apartment building) that includes the location of interest (e.g., that is an address of an apartment in the building).

Listings selected may also depend on whether a user has indicated an interest in buying or selling (e.g., listings corresponding to sales in the relevant geography level(s) may not be selected if the user has indicated an interest in buying, and vice-versa). Listings selected may also depend on whether the properties represented thereby are determined to be similar (e.g., in price, square footage, lot size, room allotment, occupancy type, usage, etc.) to a property corresponding to a location of interest entered into the system by a user. Listings selected may also depend on whether they occurred within a certain time period (e.g., in the last 24 months).

Listings selected may also depend on a relevant “segment.” A “segment” as understood by the agent analytics system 108 may include a geographic component (e.g., a geography level selected corresponding to a location of interest, as described above). The segment may further include an occupancy type (or other property type) and a price range (either/both of which may have been indicated to the agent analytics system 108 by the user device 104). In such cases were listings are selected according to segments, a geography level (e.g., corresponding to an indicate location of interest and/or that is otherwise relevant to the agent) may be identified for use in selecting listings, in the manner described. Further, it may be that listings selected according to segment methods must further match either and/or both of the occupancy type of the segment and/or that fall within the price range of the segment are excluded from the listings selection.

It is also contemplated that listings could be selected base on occupancy type and/or price range and in a manner that is not inherently associated with a geographic component within a segment. Further, any other type of data/category of data found within the sanitized agent data 124.

The set of listings for an agent in a given geography level corresponding to the desired granularity (e.g., city, region) are accordingly used. The points within the selection may accordingly be selected based on the type of desired polygon (e.g., Activity, Performance, Buyer's Side, Activity Plus Buyer's Side, etc.) The points may also be selected such that they are required to match one or more of an indicated occupancy type and/or price range, when using segments as described herein.

Upon selecting the points to use, the centroid of the corresponding polygon is calculated using those points. Then, the points (which will make up the vertices of the polygon) can be ordered by sequence, such that the line between any two consecutive vertices within the polygon does not overlap with or intersect another line between any other two consecutive vertices of the same polygon.

To perform the ordering, first an anchor for each point (vertex) is calculated and the points are anchored relative to the map upon which the polygon will eventually be drawn. In embodiments where the agent analytics system 108 has been made aware of a specific location of interest, the map may show a geography level (city, county, zip code, building, etc.) corresponding to the location of interest. Once the points are so anchored, for each point, an angle between the centroid-to-point line and the horizontal line crossing the centroid (with horizontal being relative to the ultimate orientation of the map) is calculated. The angles may then be ordered according to their values (which may include accounting for differences in quadrants based on a quadrant system centered on the centroid). Then, the points themselves may be ordered according to the ordered sequence of their corresponding angles.

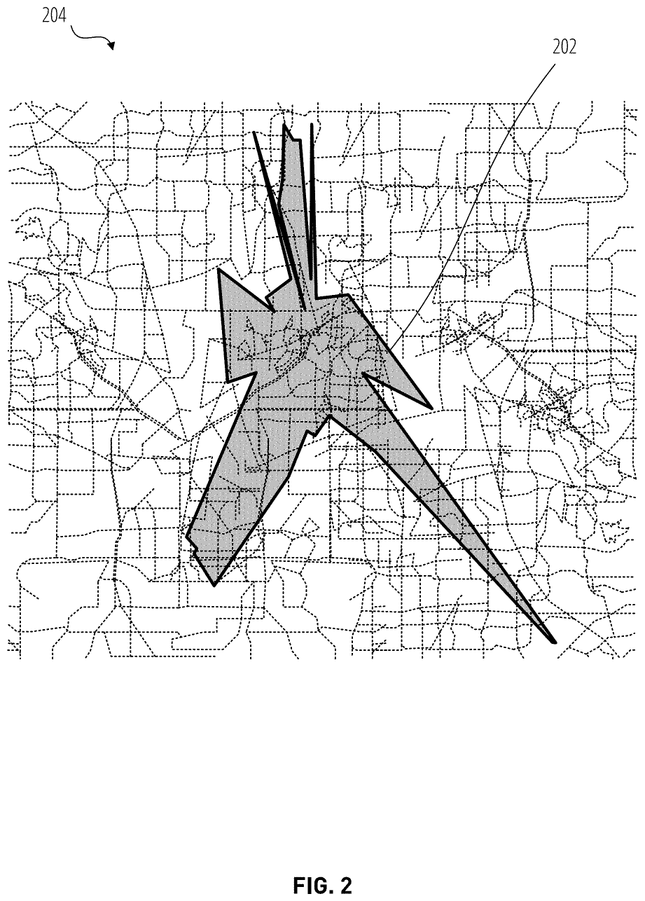

Lines can then be drawn between each pair of adjacent points in this sequence (and between the first and last point of the sequence) on the map to generate the polygon. FIG. 2 illustrates an example of the resulting polygon 202 of a polygon drawing process as just described. As shown, the polygon 202 may be ultimately displayed on top of the map 204 to enable straightforward visual analysis of the polygon. In other embodiments, the polygon 202 may be integrated into the map 204 for display.

Returning to FIG. 1: Such polygons may be expressed in the polygon data 126 in terms of their vertices as represented by GPS coordinates. The polygon data 126 may further indicate which of these vertices are connected together to form a line segment of the perimeter of the polygon.

The polygon generation engine 142 may further generate, for a polygon, using the listings that were used to create the polygon and/or listings found within/corresponding to the polygon, metrics associated with the polygon. These may include a number of insights or metrics (e.g., the number of listings for an agent within the polygon and/or per square mile of the polygon, to total number of listings within the polygon and/or per square mile of the polygon, etc.), the centroid of the polygon (e.g., in terms of GPS coordinates for the centroid), the area of the polygon (e.g., in square miles), the length of the polygon boundary (e.g., in miles), the concentration rate (e.g., the number of geo points divided by the area), and the boundary rate (the area divided by the boundary). The polygon generation engine 142 may also determine a shading level according to one or more of these insights or metrics. This information may be stored in/as part of the polygon data 126 for the polygon.

Benefits of using the agent analytics system 108 to calculate these polygons include high scalability, allowing for the computation of tens of thousands of such polygons (comprising potentially millions of points) in very short time scales (e.g., seconds or hundreds of milliseconds). Further, using the agent analytics system 108 confers a high degree of accuracy and the ability to handle unnormalized and inconsistent data gracefully and consistently, which may be important given that inconsistent data is the industry standard on a national and even state level. Finally, the use of the agent analytics system 108 in the manner described presents more insightful data (than, e.g., what is presently available on the market) regarding whether the agent will perform well for the transaction in an immediately digestible fashion for the user.

The agent performance indicator data 128 includes various performance indicators (e.g., perhaps including what are sometimes referred to in the industry as “Key Performance Indicators” (KPIs)) related to an agent as calculated by the agent performance indicator engine 144. The agent performance indicator engine 144 may take a data set from the sanitized agent data 124 for an agent and calculate various performance indicators analyzing an agent from the perspective of a potential buyer and/or a potential seller. Performance indicators so calculated may include a number of sales where the agent represented a buyer and/or the seller, a number of deals (e.g., situations where the agent was both the buyer's agent and the seller's agent), a median sale price of the properties for the related transactions, a median closing period for the properties for the related transactions (e.g., the median time duration between the close date and the pending date), a median price drop associated with the agent's listings for sale, average DOM associated with the agent's listings for sale, the agent's close rate (or percent of the agent's listings that eventually sell), the agent's property specialization (e.g., the agent's listing distribution based on property types in view of occupancy styles and/or prices), a close rate in cases where the agent represented a seller, and/or a pricing precision (list to sale price ratio) in cases where the agent represented a seller, among others. Performance indicators related to situational experience of the agent are also contemplated, such as, for example, the rate at which the agent manages purchases for investment properties rather than primary residences, the rate at which or the number of times the agent has represented a seller going through a divorce, the average number of active listings (buyer, seller, total) that the agent manages at the same time, etc. The data set used for the calculation of such performance indicators may be the same data set used to generate one or more polygons for the agent, as described above (including any segment aspects). Alternative (or additional) performance indicators may instead be generated based on a geography level that is a global granularity, a city granularity, a region granularity, a zip code granularity, or a location granularity, etc., that is other than any granularity of the polygon (and may incorporate further segment aspects for occupancy type and/or price range). In whatever case, the data set so selected may correspond to a geography level at (at whatever granularity) at or near to a specific property for which the user of the agent analytics system 108 wants to perform an analysis as indicated by the user using the user device 104, in the case that such a specific property has been indicated to the agent analytics system 108.

In some embodiments, the agent performance indicator engine 144 may further be able to calculate performance indicators for this agent performance indicator data 128 based on property type (e.g., using properties within the data set that are for certain occupancy styles and/or price ranges) (e.g., in the case where segments were not initially used to select data points for the polygon).

Note that each agent polygon type (Activity Polygon, Performance Polygon, Buyer's Agent Polygon, Activity Plus Buyer's Agent Polygon) can also be generated on a geography-level-basis (by city, county, zip code, location or other geography level), each polygon with its own set of correspondingly calculated performance indicators.

Once the data set for generating the polygon(s) is determined, the polygon(s) as described above have been generated, and the agent performance indicator data 128 has been calculated, predictions may be made based on these data sets using machine learning. Various engines used to perform machine learning processes (and their corresponding data stored in the data store 122 upon reaching an outcome) will now be described.

The agent sell prediction data 130 includes a prediction of a likelihood and/or probability that one or more agents represented in the data will be able to sell a particular property. This prediction information may be generated by an agent sell prediction engine 146, which uses a particular agent's history of sold and unsold listings in proximity to the property (as received from, e.g., the listings database(s) 102) and/or other agent experience data. The listings used to make this prediction may be the listings that were/will be used to generate one or more polygons corresponding to a given agent, in the manner described above (so that the agent sell prediction data 130 corresponding to the agent and the particular property may “match” the drawn polygon). Alternatively, the listings used may be the agent's listings based on a geography level that is a global granularity, a city granularity, a region granularity, a zip code granularity, or a location granularity, etc., that is other than any granularity of the polygon (and may incorporate further segment aspects, such as occupancy type and/or price range). In whatever case, the listings used may correspond to a geography level at or near to a specific property for which the user of the agent analytics system 108 wants to perform an analysis as indicated by the user using the user device 104.

The agent score data 132 includes a personalized score of an agent. The agent score data 132 information may be generated by an agent scoring engine 148. The score of the agent may be based on their past performance across multiple properties in an area (as received from, e.g., the listings database(s) 102). The listings used to make this prediction may be the listings that were/will be used to generate one or more polygons corresponding to these listings in the manner described above (so that the agent score data 132 corresponding to the agent and the particular property may “match” the drawn polygon). Alternatively, the listings used may be the agent's listings based on a geography level that is a global granularity, a city granularity, a region granularity, a zip code granularity, or a location granularity, etc., that is other than any granularity of the polygon (and may incorporate further segment aspects, such as occupancy type and/or price range). In whatever case, the listings used may correspond to a geography level at or near to a specific property for which the user of the agent analytics system 108 is to perform an analysis as indicated by the user using the user device 104, in the case where such a specific property has been indicated to the agent analytics system 108.

An agent's score may be calculated using one or more performance indicators, such as the performance indicators for the agent stored in the agent performance indicator data 128 (which may correspond to one or more drawn polygon(s) as described above). Performance indicators so used to calculate the score may include DOM, price drop, and/or relative close rate at different granularities of locations (among other factors). Further, it is contemplated that that predictive data generated via a machine learning process (e.g., data generated by the agent score data 132, the DOM prediction data 134, and/or the price prediction data 136) may also be used by the agent scoring engine 148 to score the agent. It is contemplated that the agent scoring engine 148 may calculate multiple scores for the agent (based on different methods) and store each of these scores in the agent score data 132.

The DOM prediction data 134 includes a prediction of how many days it will take an agent to sell a property. This prediction information may be generated by the DOM prediction engine 150. The DOM prediction corresponding to the agent may be based on their past performance across multiple properties in an area corresponding to the property (as received from, e.g., the listings database(s) 102). The listings used to make this prediction may be the listings that were/will be used to generate one or more polygons corresponding to these listings in the manner described above (so that the DOM prediction data 134 corresponding to the agent and the particular property may “match” the drawn polygon). Alternatively, the listings used may be the agent's listings based on a geography level that is a global granularity, a city granularity, a region granularity, a zip code granularity, or a location granularity, etc., that is other than any granularity of the polygon (and may incorporate further segment aspects, such as occupancy type and/or price range). In whatever case, the listings used may correspond to a geography level at or near to a specific property for which the user of the agent analytics system 108 is to perform an analysis as indicated by the user using the user device 104.

The price prediction data 136 includes a prediction of the sale price of a property that an agent may achieve (either on the purchase side or the sell side, which may be calculated separately/differently). This prediction information may be generated by the price prediction engine 152. The price prediction corresponding to the agent may be based on their past performance across multiple properties in an area corresponding to the property (as received from, e.g., the listings database(s) 102). The listings used to make this prediction may be the listings that were/will be used to generate one or more polygons corresponding to these listings in the manner described above (so that the price prediction data 136 corresponding to the agent and the particular property may “match” the drawn polygon). Alternatively, the listings used may be the agent's listings based on a geography level that is a global granularity, a city granularity, a region granularity, a zip code granularity, or a location granularity, etc., that is other than any granularity of the polygon (and may incorporate further segment aspects, such as occupancy type and/or price range). In whatever case, the listings used may correspond to a geography level at or near to a specific property for which the user of the agent analytics system 108 is to perform an analysis as indicated by the user using the user device 104. Each of the agent sell prediction engine 146, the agent scoring engine 148, the DOM prediction engine 150, and the price prediction engine 152 may generate its corresponding predictive data as described above based on an algorithm previously developed for that engine using a machine learning process. The training process is as follows: For each of these algorithms, a “label” representing the data point that should be learned (e.g., whether the property will sell, a personalized score, etc.) is identified corresponding to each of these engines. Different considerations may apply to different types of labels. For example, in the case of the agent sell prediction engine 146, the relevant label may be whether the agent will sell the property or not. This is a binary classification problem, which may be compatible with a first type of machine learning process. In another example, in the case of the price prediction data 136, the relevant label may be the price for which a listing will eventually sell for. This is a quantitative problem, which may be compatible with a second type of machine learning different than the first. Performing separate types of machine learning based on each label gives a high level of granularity, consistency, and scalability to the system. Considerations for what types of labels to learn for and the learning processes to use therefore may be selected by business experts in conjunction with data science experts.

Data with known ideal post-analysis results is then broken up into train and validation sets. The training set is used to train the model through an iterative process that focuses on further minimizing the error between the current result produced by the relevant engine and the known ideal result for that data's analysis. During each iteration, the engine is changed slightly and the output is compared to the ideal result and a previous output(s) of the iterative process to see whether the error minimization goal is being met. Once trained (e.g., once the error has been sufficiently minimized), a validation set (comprising data that the engine has not trained on) may be used with the engine to determine whether the engine is indeed providing appropriate output (e.g., output at or near the ideal) based on the input (and this process may further fine-tune the engine). It is anticipated that, for example, neural networks, deep neural networks, and the like may be used for training purposes as described herein.

Accordingly, desired predictions relative to the current inquiry at hand (e.g., the current property and/or the current agent) are made by one or more of the agent sell prediction engine 146, agent scoring engine 148, the DOM prediction engine 150, and the price prediction engine 152 (as trained as described above). In the case of a prediction related to agent performance, the inputs may be, for example, the points associated with one or more of the polygon(s) for the agent (and optionally with calculated performance indicator data) (or alternatively the agent's listings based on a global granularity, a city granularity, a region granularity, a zip code granularity, or a location granularity) may be used as inputs, as described above.

The agent analytics system 108 may use the results display engine 154 to collect one or more pieces of information from the data store 122 and display them to a user on the user device 104. For example, a graphical user interface (GUI) may be presented to the user that includes one or more polygons from the polygon data 126 for an agent against a map. The results display engine 154 may further include in this (or different) GUI(s) data from the agent performance indicator data 128, agent sell prediction data 130, agent score data 132, DOM prediction data 134, and/or price prediction data 136 relative to the agent. This data may correspond to the polygon displayed for the agent (or another calculated polygon for the agent) as described above. Alternatively, a polygon may be displayed but the data from the agent performance indicator data 128, the agent sell prediction data 130, the agent score data 132, the DOM prediction data 134, and the price prediction data 136 displayed may be instead relative to, e.g., a global granularity, a city granularity, a zip code granularity, or a location granularity.

In other words, the processes described above relative to agents, their corresponding polygons, and predictions for each agent/polygon may be performed across multiple agents (and their corresponding polygons) to enable a user of the agent analytics system 108 to compare and contrast the historical and/or predictive data corresponding to multiple agents relative to a user-provided property. For example, the user may enter an address of interest. The agent analytics system 108 may then determine, using the sanitized agent data 124, all of the agents with relevant listings data in, for example, the property's zip code and/or surrounding zip codes in the last 24 months. It is contemplated that polygons may be determined for these agents and corresponding to the relevant identified listings, in the manner described above. It may be that any agents without a sufficient number of listings in that area to generate a polygon with desired characteristics for further analysis may then be removed. For example, it may be desirable to remove all agents with fewer than three properties bought and/or sold in a zip code. As another example, it may be desirable to remove all agents with fewer than five properties bought and/or sold in the surrounding zip codes and/or city.

Once the agents to use (and their related polygons) are so identified, the agent analytics system 108 may then display these agents and their corresponding polygons to the user. In some cases, a distance between the user-provided address and each agent polygon's centroid may be determined, such that the system can further filter from these results (e.g., by displaying only agents with polygon centroids that are within a certain range, and/or displaying only a determined number of agents that are closest to the location of interest). In cases where a relevant segment for the user is known, this display may show/use polygons that correspond to that relevant segment (e.g., that are made up of/calculated using listings within the relevant geography level, a given occupancy type, and/or a given price range).

These results may be further filtered based on the agent performance indicator data 128, the agent sell prediction data 130, the agent score data 132, the DOM prediction data 134, and/or the price prediction data 136 (as each of those pieces of data is calculated) corresponding to the polygon (in the manner described above).

As discussed above, it is anticipated that the user may indicate whether they are interested in selling or purchasing the indicated property. Because an agent's performance as a “seller's agent” or listing agent (relative to sales in a given area) may differ from an agent's performance as a “buyer's agent” (relative to purchases in a given area), it is anticipated that the relevant listings for determining polygons as described herein may change for an agent (as the relevant listings of the geography level corresponding to the polygon may be limited to, e.g., the agent's sales listings when the user indicates a potential sale or the agent's purchase listings when a user indicates a potential purchase of the property). Accordingly, it is anticipated that the shapes of the polygons (and even the agents reflected by those polygons, after the filtering process described above) may change depending on whether a potential sale or a potential purchase is indicated by the user. It is further anticipated that some data would be less relevant (and accordingly not used) in one case than the other. For example, when the user is inquiring regarding agents to help them potentially purchase a property, the system may not generate or use agent sell prediction data 130 relative to that property. Accordingly, the data expressly and implicitly indicated by the polygons may also change in the purchase case as opposed to the sell case to reflect the relevant data points.

Further, display of data for one or more agents may be arrangeable according to various sections. Possible sections for the display of this information by the results display engine 154 include a global section, which may include one or more scores from, for example, the agent score data 132 for the agent and the agent's sell statistics, median price drop, average DOM, and close rate, property specialization, and sales distribution based on the property type from, e.g., the agent performance indicator data 128. Another possible section is a city level section, which may include all of the information included in the global section in addition to incorporating one or more of the polygons for the agent from the polygon data 126. A zip code level section may be identical to the city level section. A location level section may be identical to the city level section but may use polygons that are linestrings and/or point geographies. A polygon level sections may use the same information as the city level sections, but only as such applies to the bounds of the drawn polygon (e.g., is calculated using only listings included in the drawn polygon as described as an option above).

Another possible section is a team member section that may show this information in a context that is helpful for, e.g., managers of teams of agents. Note that while the description herein uses the word “agent,” it is expressly contemplated that the processes described herein could be applicable to a team of agents. For example, the agent analytics system 108 may be able to identify one or more agents who are members of a team of agents (e.g., by using information found in the listings database(s) 102). The system may implement the above processes treating each member of the agent team as the same agent (and this may be either additionally to, or alternatively to, treating each individual agent as their own agent using the above processes). Accordingly, the use (or not) of the team member section may allow for a switch between these two conceptual views.

Another possible section is a buyer's agent performance section, which may measure the agent performance on the buy side using performance indicators relevant thereto (e.g., sales stats by geographic location, buyer/seller ratio, price reduction statistics, average closing time, etc.). The use of this sections may allow the user to switch the system from, for example, generating and displaying polygons and information related thereto corresponding to a sale of the indicated property to instead generate and display polygons and information related thereto corresponding to a purchase of the indicated property.

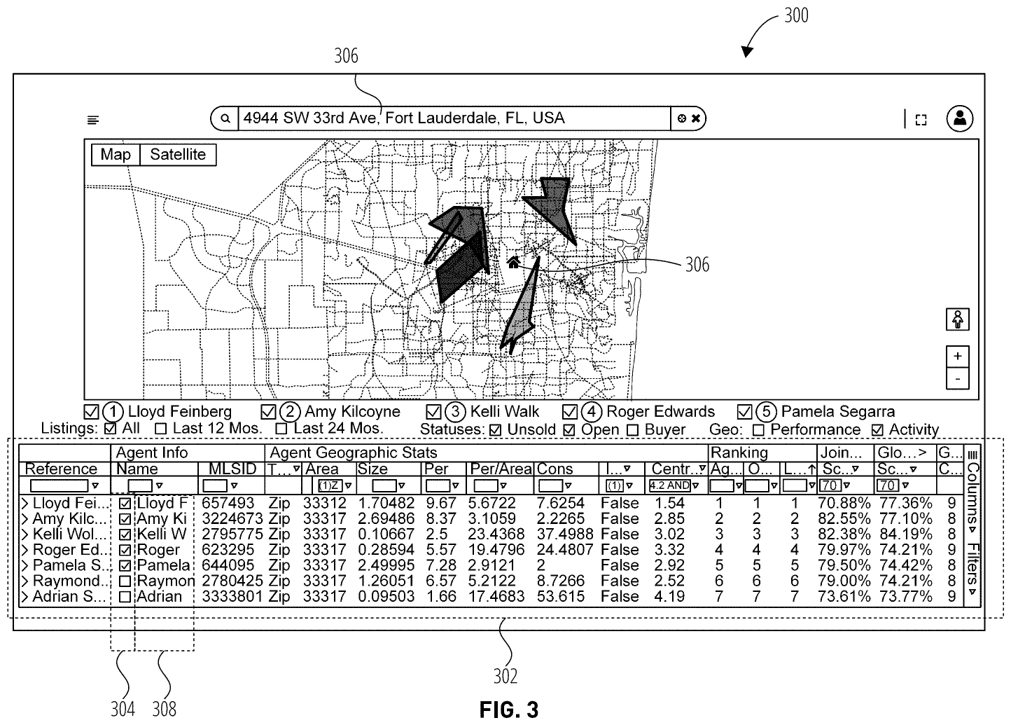

In some cases, the user of the user device 104 is a backend user (internal user), and in other cases, the user is a frontend user (end user). In whatever case, this data is sent to a user of the user device 104. FIG. 3 illustrates the presentation 300 of data on a user device of a backend user, according to embodiments herein. This presentation 300 may be provided by the results display engine 154 described above. As shown, the backend user may be presented with the results 302 related to a property 306 (e.g., a property inquired about by the backend user, or a property inquired about by another user such as a front-end user). These results may include various pieces of data corresponding to one or more agents 308 (for example, the results of the predictive engines relative to each agent in the data for the area around the inquired-of property and/or one or more polygons for respective agents in the data, as illustrated) as described herein.

Further, a selection 304 of one or more of these results may be made by agent, allowing the backend users to review the results and select the results and/or polygons that will be passed by the results display engine 154 to, for example, the front end user making the inquiry. As illustrated, in some embodiments, the presentation 300 may accordingly include polygons for those agents for which a selection 304 has been made (and not for agents for which a selection 304 has not been made) (with FIG. 3 showing five illustrated polygons in the presentation 300, one for each of the five agents for which a selection 304 has been made).

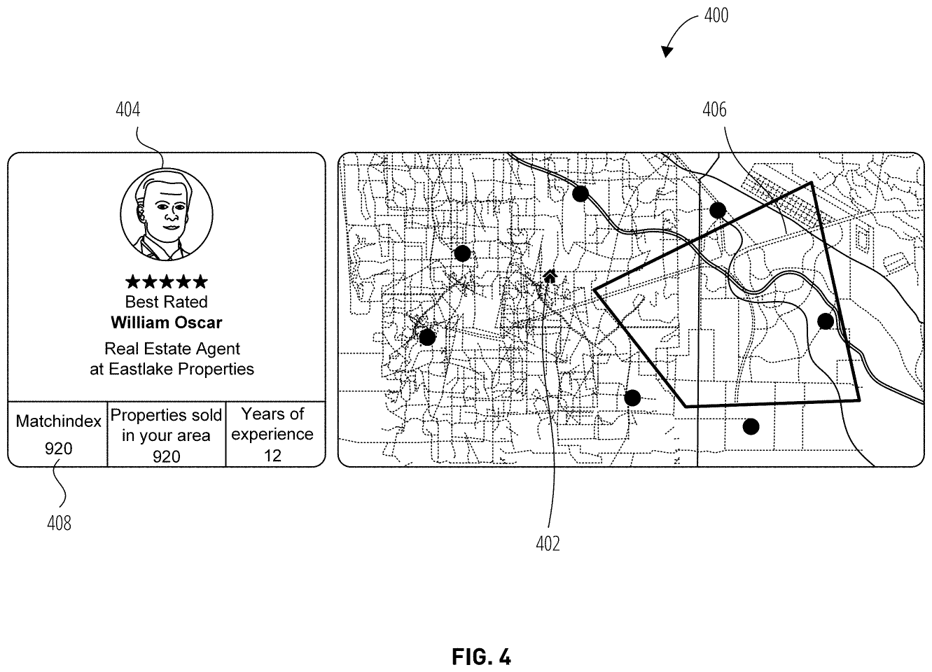

FIG. 4 illustrates the presentation 400 of data on a user device of a frontend user, according to one or more embodiments herein. On the frontend user side, a list of agents may be displayed to the frontend user along with a map illustration of the subject property 402, and the user can select an agent 404. Once an agent 404 is selected, as shown, the agent's polygon 406 (which may be simplified, as shown) and/or the agent's data (e.g., a score 408 as calculated by the agent scoring engine 148 to indicate a probability/likelihood that the agent will sell the property in an acceptable amount of time for an acceptable amount of money) may be presented as well.

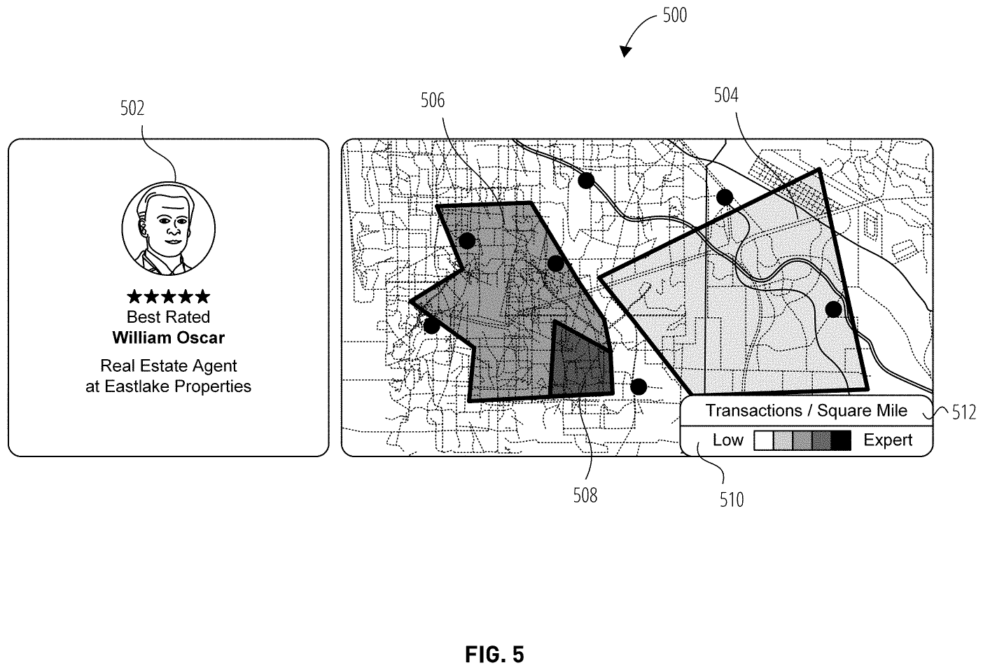

FIG. 5 illustrates the presentation 500 of data on a user device of a frontend user, according to one or more embodiments herein. On a frontend user side, the user may select an agent 502 about whom the user is interested in seeing data.

Note that in the embodiment of FIG. 5, the user may not have indicated any location of interest—rather, the user has simply identified the agent 502 to the agent analytics system 108. This identification of the agent 502 may be done by having the user search for the agent and then select them. The agent analytics system 108 may be capable of immediately jumping to the presentation 500 to show a general area in which the agent 502 operates (e.g., which can be used to show one or more polygons for that agent, as described herein).

In other embodiments, the user may have located the agent of interest by first indicating to the agent analytics system 108 a general, non-property location of interest (e.g., a city, a county, a zip code, etc.), and then selecting the agent from that list. However, it is noted that in such a case that results in the presentation 500, it is still the case that no particular property of interest has been necessarily designated to the agent analytics system 108 (as illustrated).

The presentation 500 illustrates a first polygon 504, a second polygon 506, and a third polygon 508. Each of these may have been generated as described above, using one or more listings for the agent 502.

Each of the first polygon 504, second polygon 506, and third polygon 508 may be made using listings for a geography level that is present within the presentation 500. For example, the first polygon 504 may correspond to a first geography level that is a first city, the second polygon 506 may correspond to a second geography level that is a second city, and the third polygon 508 may correspond to a geography level that is a zip code. The third polygon 508 has been illustrated as overlapped with the second polygon 506 because the zip code corresponding to the third polygon 508 covers an area found within the city corresponding to the second polygon 506—accordingly, as shown, one or more listings for the second polygon 506 for that zip code are (also) used to delineate the third polygon 508.

Note that the geography level for the polygons could vary in other embodiments. For example, it could alternatively be, for example, that the first polygon 504 corresponds to a geography level that is a first zip code, the second polygon 506 corresponds to a geography level that is a second zip code, and the third polygon 508 corresponds to a neighborhood (e.g., that is in the zip code for the second polygon 506).

The first polygon 504, the second polygon 506, and the third polygon 508 may be of the same polygon types (but this is not strictly required). For example, it may be that each of the first polygon 504, second polygon 506, and the third polygon 508 may be, e.g., a Performance Polygon, or each is an Activity Plus Buyer's Agent Polygon, or some other polygon type, with each such polygon composed using the corresponding listing types for that polygon type for the agent and according to appropriate geography levels as described herein. The use of the same polygon type for each displayed polygon (while not strictly required) may promote more straightforward understanding of the data by the user. In some embodiments, the user may be able to change and/or toggle the type(s) of the polygon(s) displayed for the agent 502 (e.g., by using a GUI interface element on the user device providing the presentation 500).

The presentation 500 may also include the heatmap index 510. This heatmap index 510 may give context to any shading that is present in any of the illustrated polygons in the presentation 500 (it is noted that different levels of such shading are seen in first polygon 504, the second polygon 506, and the third polygon 508). The use of shading in this manner (as associated with a heatmap index 510) may provide the user with a visual indication of the amount of activity that was performed by that agent within the corresponding area. As shown, units 512 corresponding to the heatmap index 510 may be displayed to the user to facilitate the more immediate understanding of the shading used. The units 512 may be in one of various possible forms, such as listings per square mile within the shaded area (as illustrated, with the word “Transactions” in FIG. 5 standing in for listings as described here), listings (total) within the shaded area, etc., with the shading appearing as determined, for example, using the polygon generation engine 142 and taken from the polygon data 126.

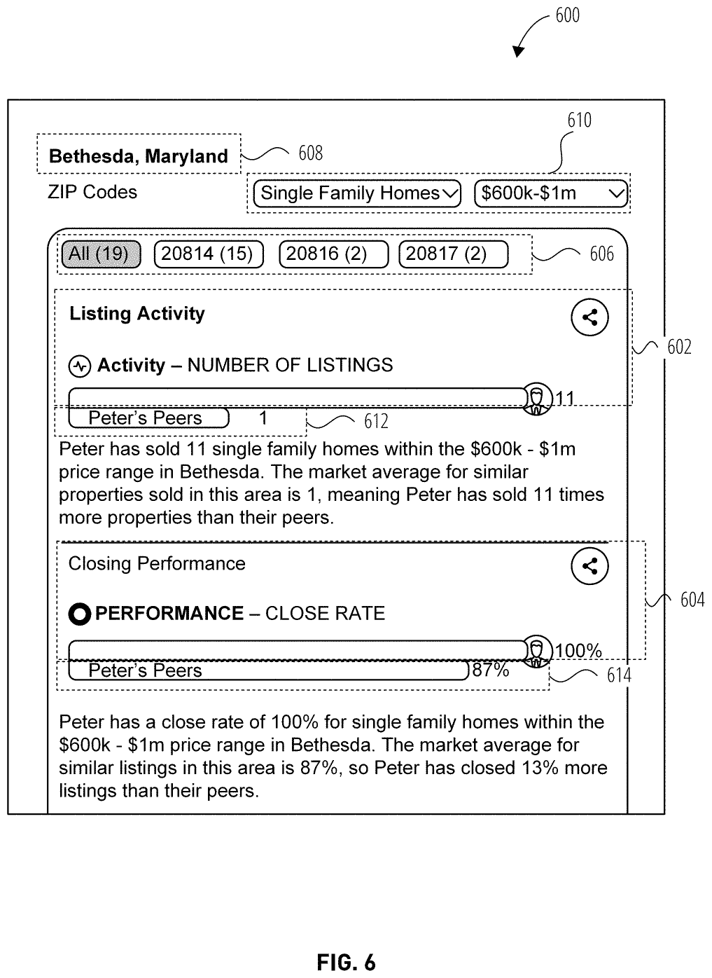

FIG. 6 illustrates a presentation 600 of data on a user device of a frontend user, according to an embodiment. The presentation 600 may appear proximate to/corresponding to a presentation as in the presentation 400 of FIG. 4 and/or the presentation 500 of FIG. 5, as these have been described herein.

The presentation 600 may be used to present and/or contextualize one or more performance indicators for the agent (e.g., as these have been calculated using (one of) the polygons for the agent (e.g., in the manner illustrated in FIG. 4 and/or FIG. 5)). In the embodiment of FIG. 6, the presentation 600 is used to present and/or contextualize a listing sales activity performance indicator 602 and a closing performance indicator 604. It is contemplated that in other embodiments, one or more other types of performance indicators (including situational experience performance indicators) could be shown instead of and/or in addition to the listing sales activity performance indicator 602 and/or the closing performance indicator 604.

As illustrated, the presentation 600 may correspond to a geography level. For example, the presentation 600 as presented in the illustrated window corresponds to the first geography level 608 for the city of Bethesda, Maryland. Further, the geography level selectors 606 are set to “All,” as illustrated. Accordingly, the performance indicator information corresponding to the listing sales activity performance indicator 602 and closing performance indicator 604 illustrate details regarding performance indicators for the agent within the city of Bethesda.

As illustrated, the user may use the geography level selectors 606 to instead select one or more zip codes within the city of Bethesda. In such an event, the agent analytics system 108 would instead provide performance indicators for the agent to the presentation 600 that are based on listings for that particular zip code. It will be understood that the use of city and zip code geography levels is provided by way of example, and not by limitation (other geography levels could be similarly arranged for use within the presentation 600).

Further, the user may be able to use property type selectors 610 to cause the agent analytics system 108 to calculate the performance indicators (e.g., the listing sales activity performance indicator 602 and the closing performance indicator 604) using only listings of a certain property type. For example, the property type selectors 610 may allow the user to specify as between occupancy styles (single-family, multi-family, condo/apartment, etc.) and/or a price range. The corresponding narrowing of the results within the selected geography level may provide the user a better understanding of how the agent performs in that area with the corresponding type of property.

The presentation 600 may also include comparative performance indication values. In the embodiment of FIG. 6, a listing activity comparative performance indication value 612 is presented alongside the listing sales activity performance indicator 602 for the agent, and a closing performance comparative performance indication value 614 is presented alongside the closing performance indicator 604 for the agent.

These comparative performance indication values (e.g., the listing activity comparative performance indication value 612 and the closing performance comparative performance indication value 614) may be calculated using listings for one or more additional agents in, for example, the same geography level. For example, the listings for these other agents may be used by the agent performance indicator engine 144 to calculate analogous performance indicators (e.g., listing activity performance indicators and closing performance indicators) for each of those other agents (in the manner described above), and these values may be averaged (e.g., by the agent performance indicator engine 144) to arrive at the comparative performance indication values. The comparative performance indication values may then be sent to the user device for use in the presentation 600.

In other embodiments, one or more performance indicators for one or more other agents may be determined by the agent performance indicator engine 144 and provided to the user device by the agent performance indicator engine 144 for use in comparing performance indicators directly (e.g., individual, agent-to-agent) corresponding to the geography level.

Each of the data store 122 (and its data) and the data engines 138 (and each of its respective engines) has been described herein as being physically present on the agent analytics system 108. However, it is contemplated (and a person of ordinary skill in the art, with the benefit of this disclosure, would understand) that any engine and/or stored data (and any combinations thereof) described as present on the agent analytics system 108 could instead be present on another computer system available to the agent analytics system 108 and operable by the agent analytics system 108 (e.g., via the network 110). This distribution of data and/or engines across multiple systems of the network 110 is expressly contemplated as within the scope of this disclosure.

It is further contemplated that any of the functionalities (e.g., the control and/or display functionalities) of the user device 104 may also occur by and/or on one or more devices directly connected to the agent analytics system 108 at, for example, the I/O interface 116.

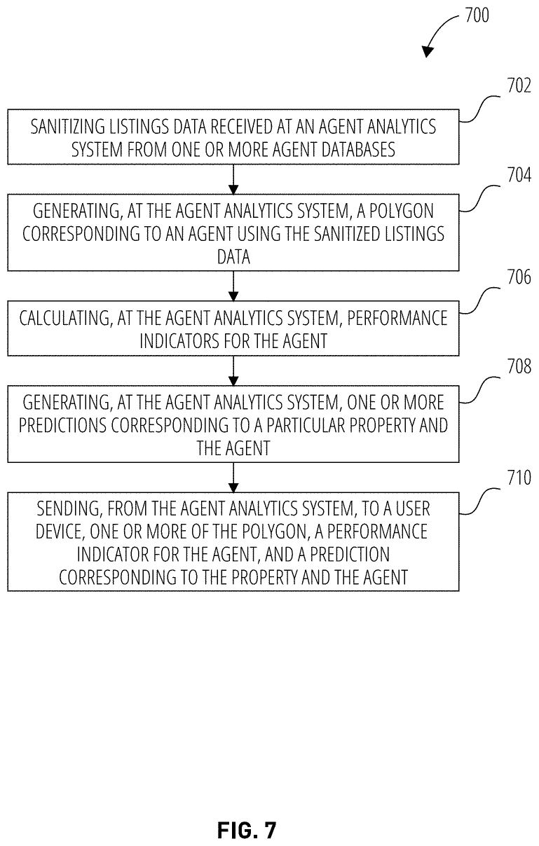

FIG. 7 is a flow diagram of a method 700 for performing real estate agent analytics, according to one or more embodiments herein. The method 700 includes sanitizing 702 listings data received at an agent analytics system from one or more agent databases. The received listings data may be placed into a single arrangement and/or file format with a single consistent set of contents and stored, in the manner described above.

The method 700 further includes generating 704, at the agent analytics system, a polygon corresponding to an agent using the sanitized listings data. These polygons may be of the types discussed above (e.g., activity, performance, buyer's side, activity plus buyer's side) and drawn over the geography levels/granularities (e.g., city, zip code, location) discussed above.

The method 700 further includes calculating 706, at the agent analytics system, performance indicators for the agent. These performance indicators may include, for example, a number of sales, a number of deals, a median price of the properties in the related transactions, a median closing period for the properties in the related transactions, a median price drop associated with the agent, average DOM associated with the agent, the agent's close rate, the agent's property specialization, and/or the agent's sales distribution based on the property type (among other possibilities) as discussed above.

The method 700 further includes generating 708, at the agent analytics system, one or more predictions corresponding to a particular property and the agent. These predictions may include, for example, an agent sell prediction, agent score data, DOM prediction data, and price prediction data, as discussed above.

The method 700 further includes sending 710, from the agent analytics system, to a user device, one or more of the polygon, a performance indicator for the agent, and a prediction corresponding to the property and the agent. Some and/or all of this information may be sent to either a backend user device or a frontend user device, as discussed above.

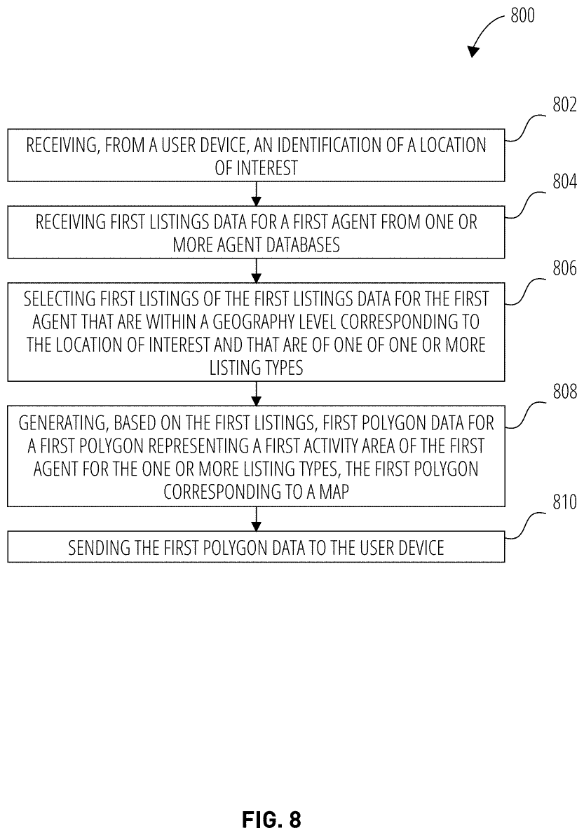

FIG. 8 illustrates a method 800 of an agent analytics system, according to an embodiment. The method 800 includes receiving 802, from a user device, an identification of a location of interest.

The method 800 further includes receiving 804 first listings data for a first agent from one or more agent databases.

The method 800 further includes selecting 806 first listings of the first listings data for the first agent that are within a geography level corresponding to the location of interest and that are of one of one or more listing types.

The method 800 further includes generating 808, based on the first listings, first polygon data for a first polygon representing a first activity area of the first agent for the one or more listing types, the first polygon corresponding to a map showing the geography level.

The method 800 further includes sending 810 the first polygon data to the user device.

In some embodiments, the method 800 further includes receiving second listings data for a second agent from the one or more agent databases; selecting second listings of the second listings data for the second agent that are within the geography level and that are of one of the one or more listing types; generating, based on the second listings, second polygon data for a second polygon representing a second activity area of the second agent for the one or more listing types, the second polygon corresponding to the map; and sending the second polygon data to the user device.

In some embodiments, the method 800 further includes sanitizing the first listings data prior to selecting the first listings.

In some embodiments, the method 800 further includes receiving an indication from the user device that identifies the one or more listing types.

In some embodiments, the method 800 further includes receiving an indication from the user device that identifies the geography level.

In some embodiments, the method 800 further includes receiving an indication from the user device that identifies the first agent.

In some embodiments of the method 800, the first polygon data comprises vertices of the first polygon that each correspond to location data for one of the first listings.

In some embodiments of the method 800, the first polygon data comprises a centroid of the first polygon determined using location data of each of the first listings.

In some embodiments of the method 800, the first polygon data comprises shading information for the polygon corresponding to an amount of the first listings.

In some embodiments of the method 800, the one or more listing types comprises sold listings for the first agent.

In some embodiments of the method 800, the one or more listing types comprises unsold listings for the first agent.

In some embodiments of the method 800, the one or more listing types comprises listings where the first agent represented a buyer.

In some embodiments of the method 800, the one or more listing types comprises listings where the first agent represented a seller.

In some embodiments, the method 800 further includes calculating, based on one or more of the first listings, a first performance indicator for the first agent; and sending, to the user device, the performance indicator. In some of these embodiments, the first performance indicator is a median sale price. In some of these embodiments, the first performance indicator is a median closing period. In some of these embodiments, the one or more of the first listings are each for a property of an indicated occupancy type. In some of these embodiments, the one or more of the first listings are each for a property within an indicated price range. Some of these embodiments further include generating a score for the first agent based on the first performance indicator; and sending, to the user device, the score. Some of these embodiments further include calculating, based on second listings for a second agent, a second performance indicator for the second agent; and sending, to the user device, the second performance indicator. Some of these embodiments further include calculating, based on additional listings for one or more additional agents, a comparative performance indication value for the one or more additional agents; and sending, to the user device, the comparative performance indication value.

In some embodiments of the method 800, the location of interest identifies a property of interest, and the method 800 further includes generating, based on the first listings, a prediction corresponding to the property of interest and the first agent; and sending, to the user device, the prediction. In some of these embodiments, the prediction represents a likelihood that the first agent will sell the property of interest. In some of these embodiments, the prediction is of a number of days that it will take the first agent to sell the property of interest. In some of these embodiments, the prediction is of a price at which the first agent will sell the property of interest.

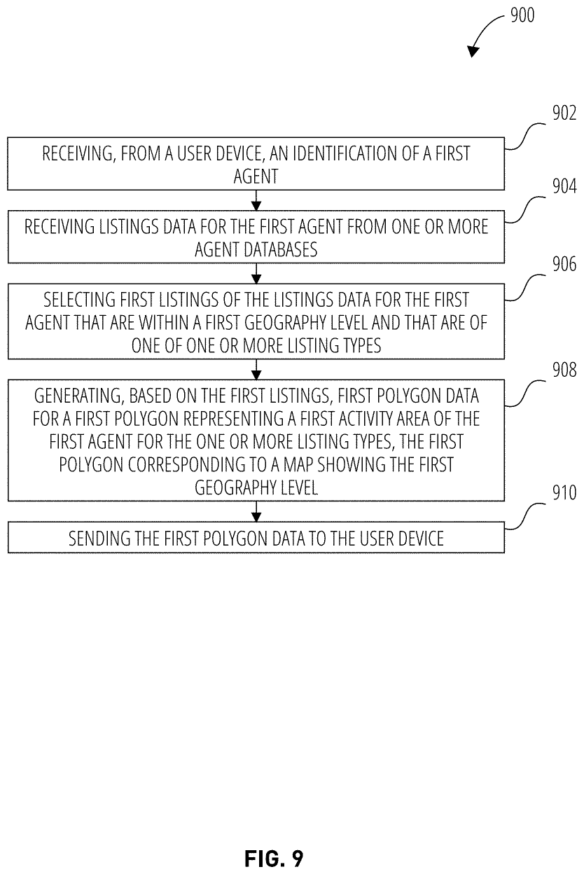

FIG. 9 illustrates a method 900 of an agent analytics system, according to an embodiment. The method 900 includes receiving 902, from a user device, an identification of a first agent.

The method 900 further includes receiving 904 listings data for the first agent from one or more agent databases.

The method 900 further includes selecting 906 first listings of the listings data for the first agent that are within a first geography level and that are of one of one or more listing types.

The method 900 further includes generating 908, based on the first listings, first polygon data for a first polygon representing a first activity area of the first agent for the one or more listing types, the first polygon corresponding to a map showing the first geography level.

The method 900 further includes sending 910 the first polygon data to the user device.

In some embodiments, the method 900 further includes selecting second listings of the listings data for the first agent that are within a second geography level and that are of one of the one or more listing types; generating, based on the second listings, second polygon data for a second polygon representing a second activity area of the first agent for the one or more listing types, the second polygon corresponding to the map, wherein the map shows the second geography level; and sending the second polygon data to the user device.

In some embodiments, the method 900 further includes sanitizing the listings data prior to selecting the first listings.

In some embodiments, the method 900 further includes receiving an indication from the user device that identifies the one or more listing types.

In some embodiments, the method 900 further includes receiving an indication from the user device that identifies the geography level.

In some embodiments, the method 900 further includes receiving an indication from the user device that identifies a location of interest, wherein the first listings are selected based on their proximity to the location of interest.

In some embodiments of the method 900, the first polygon data comprises vertices of the first polygon that each correspond to location data for one of the first listings.

In some embodiments of the method 900, the first polygon data comprises a centroid of the first polygon determined using location data of each of the first listings.

In some embodiments of the method 900, the first polygon data comprises shading information for the polygon corresponding to an amount of the first listings.

In some embodiments of the method 900, the one or more listing types comprises sold listings for the first agent.

In some embodiments of the method 900, the one or more listing types comprises unsold listings for the first agent.

In some embodiments of the method 900, the one or more listing types comprises listings where the first agent represented a buyer.

In some embodiments of the method 900, wherein the one or more listing types comprises listings where the first agent represented a seller.

In some embodiments, the method 900 further includes calculating, based on one or more of the first listings, a first performance indicator for the first agent; and sending, to the user device, the first performance indicator. In some of these embodiments, the first performance indicator is a median sale price. In some of these embodiments, the first performance indicator is a median closing period. In some of these embodiments, the one or more of the first listings are each for a property of an indicated occupancy type. In some of these embodiments, the one or more of the first listings are each for a property within an indicated price range. Some of these embodiments further include generating a score for the first agent based on the first performance indicator; and sending, to the user device, the score. Some of these embodiments further include calculating, based on second listings for a second agent, a second performance indicator for the second agent; and sending, to the user device, the second performance indicator. Some of these embodiments further include calculating, based on additional listings for one or more additional agents, a comparative performance indication value for the one or more additional agents; and sending, to the user device, the comparative performance indication value.

In some embodiments, the method 900 further includes receiving an indication from the user device that identifies a property of interest; generating, based on the first listings, a prediction corresponding to the property of interest and the first agent; and sending, to the user device, the prediction. In some of these embodiments, the prediction represents a likelihood that the first agent will sell the property of interest. In some of these embodiments, the prediction is of a number of days that it will take the first agent to sell the property of interest. In some of these embodiments, the prediction is of a price at which the first agent will sell the property of interest.

### EXAMPLES

Example 1. A method of agent analytics, comprising: receiving, from a user device, an identification of a location of interest; receiving first listings data for a first agent from one or more agent databases; selecting first listings of the first listings data for the first agent that are within a geography level corresponding to the location of interest and that are of one of one or more listing types; generating, based on the first listings, first polygon data for a first polygon representing a first activity area of the first agent for the one or more listing types, the first polygon corresponding to a map showing the geography level; and sending the first polygon data to the user device.

Example 2. The method of Example 1, further comprising: receiving second listings data for a second agent from the one or more agent databases; selecting second listings of the second listings data for the second agent that are within the geography level and that are of one of the one or more listing types; generating, based on the second listings, second polygon data for a second polygon representing a second activity area of the second agent for the one or more listing types, the second polygon corresponding to the map; and sending the second polygon data to the user device.

Example 3. The method of Example 1, further comprising sanitizing the first listings data prior to selecting the first listings.

Example 4. The method of Example 1, further comprising receiving an indication from the user device that identifies the one or more listing types.

Example 5. The method of Example 1, further comprising receiving an indication from the user device that identifies the geography level.

Example 6. The method of Example 1, further comprising receiving an indication from the user device that identifies the first agent.

Example 7. The method of Example 1, wherein the first polygon data comprises vertices of the first polygon that each correspond to location data for one of the first listings.

Example 8. The method of Example 1, wherein the first polygon data comprises a centroid of the first polygon determined using location data of each of the first listings.

Example 9. The method of Example 1, wherein the first polygon data comprises shading information for the polygon corresponding to an amount of the first listings.

Example 10. The method of Example 1, wherein the one or more listing types comprises sold listings for the first agent.

Example 11. The method of Example 1, wherein the one or more listing types comprises unsold listings for the first agent.

Example 12. The method of Example 1, wherein the one or more listing types comprises listings where the first agent represented a buyer.

Example 13. The method of Example 1, wherein the one or more listing types comprises listings where the first agent represented a seller.

Example 14. The method of Example 1, further comprising: calculating, based on one or more of the first listings, a first performance indicator for the first agent; and sending, to the user device, the performance indicator.

Example 15. The method of Example 14, wherein the first performance indicator is a median sale price.

Example 16. The method of Example 14, wherein the first performance indicator is a median closing period.

Example 17. The method of Example 14, wherein the one or more of the first listings are each for a property of an indicated occupancy type.

Example 18. The method of Example 14, wherein the one or more of the first listings are each for a property within an indicated price range.

Example 19. The method of Example 14, further comprising: generating a score for the first agent based on the first performance indicator; and sending, to the user device, the score.

Example 20. The method of Example 14, further comprising: calculating, based on second listings for a second agent, a second performance indicator for the second agent; and sending, to the user device, the second performance indicator.

Example 21. The method of Example 14, further comprising: calculating, based on additional listings for one or more additional agents, a comparative performance indication value for the one or more additional agents; and sending, to the user device, the comparative performance indication value.

Example 22. The method of Example 1, wherein the location of interest identifies a property of interest, and further comprising: generating, based on the first listings, a prediction corresponding to the property of interest and the first agent; and sending, to the user device, the prediction.

Example 23. The method of Example 22, wherein the prediction represents a likelihood that the first agent will sell the property of interest.

Example 24. The method of Example 22, wherein the prediction is of a number of days that it will take the first agent to sell the property of interest.

Example 25. The method of Example 22, wherein the prediction is of a price at which the first agent will sell the property of interest.

Example 26. A method of agent analytics, comprising: receiving, from a user device, an identification of a first agent; receiving listings data for the first agent from one or more agent databases; selecting first listings of the listings data for the first agent that are within a first geography level and that are of one of one or more listing types; generating, based on the first listings, first polygon data for a first polygon representing a first activity area of the first agent for the one or more listing types, the first polygon corresponding to a map showing the first geography level; and sending the first polygon data to the user device.

Example 27. The method of Example 26, further comprising: selecting second listings of the listings data for the first agent that are within a second geography level and that are of one of the one or more listing types; generating, based on the second listings, second polygon data for a second polygon representing a second activity area of the first agent for the one or more listing types, the second polygon corresponding to the map, wherein the map shows the second geography level; and sending the second polygon data to the user device.

Example 28. The method of Example 26, further comprising sanitizing the listings data prior to selecting the first listings.

Example 29. The method of Example 26, further comprising receiving an indication from the user device that identifies the one or more listing types.

Example 30. The method of Example 26, further comprising receiving an indication from the user device that identifies the geography level.

Example 31. The method of Example 26, further comprising receiving an indication from the user device that identifies a location of interest, wherein the first listings are selected based on their proximity to the location of interest.

Example 32. The method of Example 26, wherein the first polygon data comprises vertices of the first polygon that each correspond to location data for one of the first listings.

Example 33. The method of Example 26, wherein the first polygon data comprises a centroid of the first polygon determined using location data of each of the first listings.

Example 34. The method of Example 26, wherein the first polygon data comprises shading information for the polygon corresponding to an amount of the first listings.

Example 35. The method of Example 26, wherein the one or more listing types comprises sold listings for the first agent.

Example 36. The method of Example 26, wherein the one or more listing types comprises unsold listings for the first agent.

Example 37. The method of Example 26, wherein the one or more listing types comprises listings where the first agent represented a buyer.

Example 38. The method of Example 26, wherein the one or more listing types comprises listings where the first agent represented a seller.

Example 39. The method of Example 26, further comprising: calculating, based on one or more of the first listings, a first performance indicator for the first agent; and sending, to the user device, the first performance indicator.

Example 40. The method of Example 39, wherein the first performance indicator is a median sale price.

Example 41. The method of Example 39, wherein the first performance indicator is a median closing period.

Example 42. The method of Example 39, wherein the one or more of the first listings are each for a property of an indicated occupancy type.

Example 43. The method of Example 39, wherein the one or more of the first listings are each for a property within an indicated price range.

Example 44. The method of Example 39, further comprising: generating a score for the first agent based on the first performance indicator; and sending, to the user device, the score.

Example 45. The method of Example 39, further comprising: calculating, based on second listings for a second agent, a second performance indicator for the second agent; and sending, to the user device, the second performance indicator.

Example 46. The method of Example 39, further comprising: calculating, based on additional listings for one or more additional agents, a comparative performance indication value for the one or more additional agents; and sending, to the user device, the comparative performance indication value.

Example 47. The method of Example 26, further comprising: receiving an indication from the user device that identifies a property of interest; generating, based on the first listings, a prediction corresponding to the property of interest and the first agent; and sending, to the user device, the prediction.

Example 48. The method of Example 47, wherein the prediction represents a likelihood that the first agent will sell the property of interest.

Example 49. The method of Example 47, wherein the prediction is of a number of days that it will take the first agent to sell the property of interest.

Example 50. The method of Example 47, wherein the prediction is of a price at which the first agent will sell the property of interest.

Example 51. An agent analytics system, comprising: one or more processors; and a memory comprising instructions that, when executed by the one or more processors, causes the one or more processors to configure the agent analytics system to: receive, from a user device, an identification of a location of interest; receive first listings data for a first agent from one or more agent databases; select first listings of the first listings data for the first agent that are within a geography level corresponding to the location of interest and that are of one of one or more listing types; generate, based on the first listings, first polygon data for a first polygon representing a first activity area of the first agent for the one or more listing types, the first polygon corresponding to a map showing the geography level; and send the first polygon data to the user device.

Example 52. An agent analytics system, comprising: one or more processors; and a memory comprising instructions that, when executed by the one or more processors, causes the one or more processors to configure the agent analytics system to: receive, from a user device, an identification of a first agent; receive listings data for the first agent from one or more agent databases; select first listings of the listings data for the first agent that are within a first geography level and that are of one of one or more listing types; generate, based on the first listings, first polygon data for a first polygon representing a first activity area of the first agent for the one or more listing types, the first polygon corresponding to a map showing the first geography level; and send the first polygon data to the user device.

Example 53. A non-transitory computer readable medium storing instructions that, when executed by one or more processors of an agent analytics system, cause the one or more processors to configure the agent analytics system to: receive, from a user device, an identification of a location of interest; receive first listings data for a first agent from one or more agent databases; select first listings of the first listings data for the first agent that are within a geography level corresponding to the location of interest and that are of one of one or more listing types; generate, based on the first listings, first polygon data for a first polygon representing a first activity area of the first agent for the one or more listing types, the first polygon corresponding to a map showing the geography level; and send the first polygon data to the user device.

Example 54. A non-transitory computer readable medium storing instructions that, when executed by one or more processors of an agent analytics system, cause the one or more processors to configure the agent analytics system to: receive, from a user device, an identification of a first agent; receive listings data for the first agent from one or more agent databases; select first listings of the listings data for the first agent that are within a first geography level and that are of one of one or more listing types; generate, based on the first listings, first polygon data for a first polygon representing a first activity area of the first agent for the one or more listing types, the first polygon corresponding to a map showing the first geography level; and send the first polygon data to the user device.

The foregoing specification has been described with reference to various embodiments, including the best mode. However, those skilled in the art appreciate that various modifications and changes can be made without departing from the scope of the present disclosure and the underlying principles of the invention. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

Embodiments herein may include various engines, which may be embodied in machine-executable instructions to be executed by a general-purpose or special-purpose computer (or other electronic device). Alternatively, the engine functionality may be performed by hardware components that include specific logic for performing the function(s) of the engines, or by a combination of hardware, software, and/or firmware.

Principles of the present disclosure may be reflected in a computer program product on a tangible computer-readable storage medium having stored instructions thereon that may be used to program a computer (or other electronic device) to perform processes described herein. Any suitable computer-readable storage medium may be utilized, including magnetic storage devices (hard disks, floppy disks, and the like), optical storage devices (CD-ROMs, DVDs, Blu-Ray discs, and the like), flash memory, and/or other types of medium/machine readable medium suitable for storing electronic instructions. These instructions may be loaded onto a general purpose computer, special purpose computer, or other programmable data processing apparatus to produce a machine, such that the instructions that execute on the computer or other programmable data processing apparatus create means for implementing the functions specified. These instructions may also be stored in a computer-readable memory that can direct a computer or other programmable data processing apparatus to function in a particular manner, such that the instructions stored in the computer-readable memory produce an article of manufacture including instruction means which implement the function specified. The instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified.

Principles of the present disclosure may be reflected in a computer program implemented as one or more software modules or components. As used herein, a software module or component may include any type of computer instruction or computer-executable code located within a memory device and/or computer-readable storage medium. A software module may, for instance, comprise one or more physical or logical blocks of computer instructions, which may be organized as a routine, a program, an object, a component, a data structure, etc., that perform one or more tasks or implement particular data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Suitable software to assist in implementing the invention is readily provided by those of skill in the pertinent art(s) using the teachings presented here and programming languages and tools, such as Java, JavaScript, Pascal, C++, C, database languages, APIs, SDKs, assembly, firmware, microcode, and/or other languages and tools.

Embodiments as disclosed herein may be computer-implemented in whole or in part on a digital computer. The digital computer includes a processor performing the required computations. The computer further includes a memory in electronic communication with the processor to store a computer operating system. The computer operating systems may include, but are not limited to, MS-DOS, Windows, Linux, Unix, AIX, CLIX, QNX, OS/2, and MacOS. Alternatively, it is expected that future embodiments will be adapted to execute on other future operating systems.

It will be obvious to those having skill in the art that many changes may be made to the details of the above-described embodiments without departing from the underlying principles of the invention. The scope of the present invention should, therefore, be determined only by the following claims.

1. An agent analytics system, comprising:
one or more processors; and
a memory comprising instructions that, when executed by the one or more processors, causes the one or more processors to configure the agent analytics system to:
receive, from a user device, an identification of a location of interest;
receive first listings data for a first agent from one or more agent databases;
select first listings of the first listings data for the first agent that are within a geography level corresponding to the location of interest and that are of one of one or more listing types;
generate, based on the first listings, first polygon data for a first polygon representing a first activity area of the first agent for the one or more listing types, the first polygon corresponding to a map showing the geography level; and
send the first polygon data to the user device.

2. The agent analytics system of claim 1, wherein the instructions, when executed by the one or more processors, further cause the one or more processors to configure the agent analytics system to:
receive second listings data for a second agent from the one or more agent databases;
select second listings of the second listings data for the second agent that are within the geography level and that are of one of the one or more listing types;
generate, based on the second listings, second polygon data for a second polygon representing a second activity area of the second agent for the one or more listing types, the second polygon corresponding to the map; and
send the second polygon data to the user device.

3. The agent analytics system of claim 1, wherein the instructions, when executed by the one or more processors, further cause the one or more processors to configure the agent analytics system to sanitize the first listings data prior to selecting the first listings.

4. The agent analytics system of claim 1, wherein the instructions, when executed by the one or more processors, further cause the one or more processors to configure the agent analytics system to receive an indication from the user device that identifies the one or more listing types.

5. The agent analytics system of claim 1, wherein the instructions, when executed by the one or more processors, further cause the one or more processors to configure the agent analytics system to receive an indication from the user device that identifies the geography level.

6. The agent analytics system of claim 1, wherein the instructions, when executed by the one or more processors, further cause the one or more processors to configure the agent analytics system to receive an indication from the user device that identifies the first agent.

7. The agent analytics system of claim 1, wherein the first polygon data comprises vertices of the first polygon that each correspond to location data for one of the first listings.

8. The agent analytics system of claim 1, wherein the first polygon data comprises a centroid of the first polygon determined using location data of each of the first listings.

9. The agent analytics system of claim 1, wherein the first polygon data comprises shading information for the polygon corresponding to an amount of the first listings.

10. The agent analytics system of claim 1, wherein the one or more listing types comprises sold listings for the first agent.

11. The agent analytics system of claim 1, wherein the one or more listing types comprises listings where the first agent represented a buyer.

12. The agent analytics system of claim 1, wherein the location of interest identifies a property of interest, and wherein the instructions, when executed by the one or more processors, further cause the one or more processors to configure the agent analytics system to:
generate, based on the first listings, a prediction corresponding to the property of interest and the first agent; and
send, to the user device, the prediction.

13. The agent analytics system of claim 12, wherein the prediction represents a likelihood that the first agent will sell the property of interest.

14. An agent analytics system, comprising:
one or more processors; and
a memory comprising instructions that, when executed by the one or more processors, causes the one or more processors to configure the agent analytics system to:
receive, from a user device, an identification of a first agent;
receive listings data for the first agent from one or more agent databases;
select first listings of the listings data for the first agent that are within a first geography level and that are of one of one or more listing types;
generate, based on the first listings, first polygon data for a first polygon representing a first activity area of the first agent for the one or more listing types, the first polygon corresponding to a map showing the first geography level; and
send the first polygon data to the user device.

15. The agent analytics system of claim 14, wherein the instructions, when executed by the one or more processors, further cause the one or more processors to configure the agent analytics system to:
select second listings of the listings data for the first agent that are within a second geography level and that are of one of the one or more listing types;
generate, based on the second listings, second polygon data for a second polygon representing a second activity area of the first agent for the one or more listing types, the second polygon corresponding to the map, wherein the map shows the second geography level; and
send the second polygon data to the user device.

16. The agent analytics system of claim 14, wherein the instructions, when executed by the one or more processors, further cause the one or more processors to configure the agent analytics system to receive an indication from the user device that identifies a location of interest, wherein the first listings are selected based on their proximity to the location of interest.

17. The agent analytics system of claim 14, wherein the instructions, when executed by the one or more processors, further cause the one or more processors to configure the agent analytics system to:
calculate, based on one or more of the first listings, a first performance indicator for the first agent; and
send, to the user device, the performance indicator.

18. The agent analytics system of claim 17, wherein the first performance indicator is a median sale price.

19. The agent analytics system of claim 17, wherein the first performance indicator is a median closing period.

20. The agent analytics system of claim 17, wherein the one or more of the first listings are each for a property of an indicated occupancy type.

21. The agent analytics system of claim 17, wherein the one or more of the first listings are each for a property within an indicated price range.

22. The agent analytics system of claim 17, wherein the instructions, when executed by the one or more processors, further cause the one or more processors to configure the agent analytics system to:
generate a score for the first agent based on the first performance indicator; and
send, to the user device, the score.

23. The agent analytics system of claim 17, wherein the instructions, when executed by the one or more processors, further cause the one or more processors to configure the agent analytics system to:
calculate, based on additional listings for one or more additional agents, a comparative performance indication value for the one or more additional agents; and
send, to the user device, the comparative performance indication value.
